(19) United States
(12) Patent Application Publication
(10) Pub. No.: US 2009/0219081 A1
(43) Pub. Date: Sep. 3, 2009

(54) INTERNAL VOLTAGE GENERATOR OF SEMICONDUCTOR MEMORY DEVICE

(75) Inventors: Jae-Kwan KWON, Gyeonggi-do (KR); Yee-Yul Kim, Gyeonggi-do (KR)

Correspondence Address: MANNAVA & KANG, P.C., 11240 WAPLES MILL ROAD, Suite 300, FAIRFAX, VA, 22030, US

(73) Assignee: HYNIX SEMICONDUCTOR, INC., Gyeonggi-do (KE)

(21) Appl. No.: 12/266,623

(22) Filed: Nov. 7, 2008

(30) Foreign Application Priority Data
Mar. 3, 2008 (KR) 10-2008-0019682

(51) Int. Cl. H02M 3/139

(52) U.S. Cl. 327/536

(57) ABSTRACT

An internal voltage generation circuit of semiconductor memory device includes a reference voltage generation unit configured to generate a reference voltage, and a pumping control unit configured to be enabled at every active mode, compare the reference voltage with a fed-back voltage of a pumping voltage terminal, and output a pumping enable signal based on a comparison result. A storage unit is configured to store and output the pumping enable signal outputted from the pumping control unit. A charge pumping unit is configured to drive the pumping voltage terminal by performing a charge pumping operation in response to the pumping enable signal outputted from the storage unit.

### CROSS-REFERENCE TO RELATED APPLICATION

The present invention claims priority from Korean patent application number 10-2008-0019682, filed on Mar. 3, 2008, which is incorporated by reference in its entirety.

### BACKGROUND OF THE INVENTION

The present invention relates to an internal voltage generator of a semiconductor memory device, and more particularly, to an internal voltage generator of a semiconductor memory device for reducing the amount of current consumed in the generation of an internal voltage using a charge pump.

A semiconductor memory device receives a power voltage VDD and a ground voltage VSS from an external, and generates a high voltage VPP as an internal voltage higher than the power voltage VDD.

When a cell transistor which determines access to a cell is turned on, the high voltage VPP is used to prevent data loss from the cell by applying a voltage higher than an external power voltage.

Hereinafter, a conventional internal voltage generator will be described.

FIG. 1 is a block diagram illustrating a conventional internal voltage generation circuit of a semiconductor memory device.

As shown in FIG. 1, a conventional internal voltage generation circuit includes a reference voltage generation unit 110, a pumping control unit 120 and a charge pumping unit 130.

The charge voltage generation unit 110 divides a predetermined voltage and generates a reference voltage VREF. The predetermined voltage may be a power voltage VDD or a voltage having a predetermined value for the variation of PVT (Process, Voltage and Temperature) generated by a band-gap circuit of a chip.

The pumping control unit 120 compares a fed-back pumping voltage, e.g., ⅓*VPP, with a reference voltage VREF, and generates a pumping enable signal PUMP_EN. When a pumping voltage VPP is fed back to the pumping control unit 120, the pumping voltage VPP is lowered by the voltage dividing unit 140. Because the pumping voltage VPP is higher than the power voltage VDD and it is difficult to compare the pumping voltage VPP with other voltages.

If the fed-back pumping voltage is lower than the reference voltage VREF, that is, a level of the pumping voltage VPP is not high enough, the pumping control unit enables and outputs the pumping enable signal PUMP_EN, which performs a pumping operation of the charge pumping unit 130.

On the contrary, if the fed-back pumping voltage, e.g., ⅓*VPP, is higher than the reference voltage VREF, that is, a level of the pumping voltage VPP is enough high, the pumping control unit disables and outputs the pumping enable signal PUMP_EN.

The pumping enable signal PUMP_EN may be designed to be enabled as ‘high’ or ‘low’.

If the pumping enable signal PUMP_EN is enabled, the charge pumping unit 130 raises the pumping voltage VPP by performing a pumping operation. If the pumping enable signal PUMP_EN is disabled, the pumping operation is not performed by the charge pumping unit 130.

The charge pumping unit 130 includes an oscillator, a control circuit and a charge pump. The oscillator generates a periodic wave in response to the pumping enable signal PUMP_EN. The control circuit outputs a pump driving signal in response to the periodic wave outputted from the oscillator. The charge pump performs the pumping of a charge in response to the pump driving signal.

The detailed descriptions for the charge pump unit are omitted because the charge pump unit may be easily designed by a skilled person in a related art.

A conventional internal voltage generation circuit consumes a current continuously on the reference voltage generation unit 110 and the pumping control unit 120. The reference voltage generation unit 110 divides a predetermined voltage and generates a reference voltage. In the reference voltage generation unit 110, a predetermined voltage terminal is coupled to a ground voltage terminal through resistors. Accordingly, the current flows always on the ground voltage terminal.

The pumping control unit includes a general comparator, and consumes a lot of current since a differential amplifier of the comparator consumes the current always.

Moreover, the semiconductor memory device has a plurality of charge pumping units 130 to generate a high voltage VPP as an internal voltage, and has a plurality of pumping control units to control each of the plurality of charge pumping units 130. A current quantity consumed in the pumping control units is not negligible, and to reduce the current consumption of the pumping control units is an important issue.

### SUMMARY OF THE INVENTION

Embodiments of the present invention are directed to providing an internal voltage generator of a semiconductor memory device for reducing a current consumption of a semiconductor memory device by preventing an internal voltage generator from consuming a lot of current.

In accordance with an aspect of the invention, there is provided an internal voltage generation circuit of semiconductor memory device, including: a reference voltage generation unit configured to generate a reference voltage; a pumping control unit configured to be enabled at every active mode, compare the reference voltage with a fed-back voltage of a pumping voltage terminal, and output a pumping enable signal based on a comparison result; a storage unit configured to store and output the pumping enable signal outputted from the pumping control unit; and a charge pumping unit configured to drive the pumping voltage terminal by performing a charge pumping operation in response to the pumping enable signal outputted from the storage unit.

In accordance with another aspect of the invention, there is provided an internal voltage generation circuit of semiconductor memory device, including: a reference voltage generation unit configured to generate a reference voltage; a counter unit configured to enable and output a control enable signal when an active mode is performed repeatedly a predetermined number times; a pumping control unit configured to be enabled in the control enable signal, compare the reference voltage with a fed-back voltage of a pumping voltage terminal, and outputs a pumping enable signal based on a comparison result; a storage unit configured to store and output the pumping enable signal outputted from the pumping control unit; and a charge pumping unit configured to drive the pumping voltage terminal by performing a charge pumping operation in response to the pumping enable signal outputted from the storage unit.

### BRIEF DESCRIPTION OF THE DRAWINGS

FIG. 1 is a block diagram illustrating a conventional internal voltage generation circuit of a semiconductor memory device.

FIG. 2 is a block diagram illustrating an internal voltage generation circuit of a semiconductor memory device in accordance with an embodiment of the present invention.

FIG. 3 illustrates an embodiment of a detailed configuration of the pumping control unit shown in FIG. 2.

FIG. 4 illustrates an embodiment of a detailed configuration of the storage unit shown in FIG. 2.

FIG. 5 is a block diagram illustrating an internal voltage generation circuit of a semiconductor memory device in accordance with another embodiment of the invention.

FIG. 6 illustrates an embodiment of a detailed configuration of the counter unit shown in FIG. 5.

FIG. 7 is a timing block illustrating an operation of the counter unit shown in FIG. 6.

### DESCRIPTION OF SPECIFIC EMBODIMENTS

Hereinafter, an internal generation circuit of a semiconductor memory device in accordance with the present invention will be described in detail with reference to the accompanying drawings.

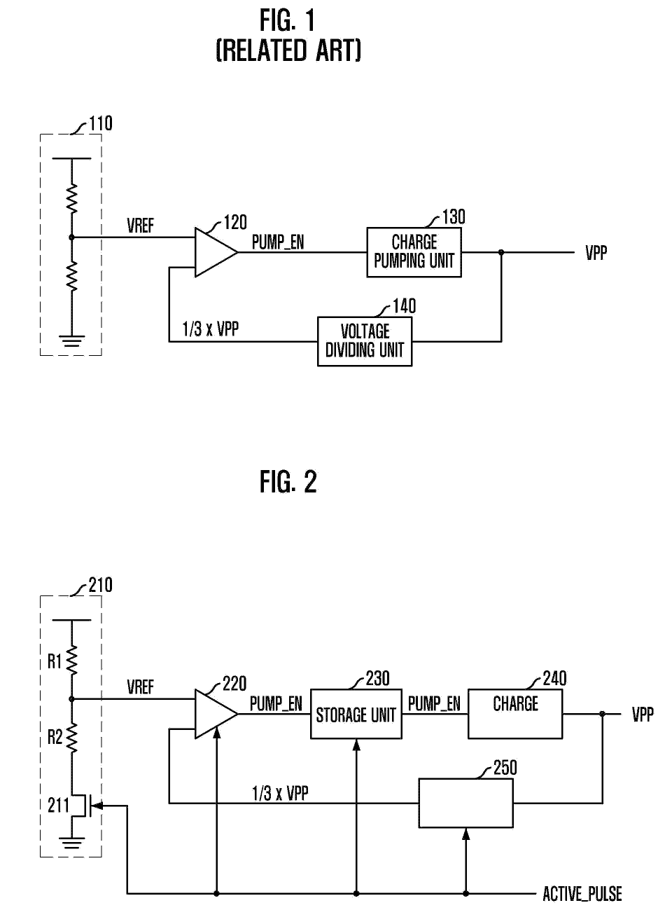

FIG. 2 is a block diagram illustrating an internal voltage generation circuit of a semiconductor memory device in accordance with an embodiment of the invention.

An internal generation circuit of a semiconductor memory device in accordance with an embodiment of the invention includes a reference voltage generation unit 210, a pumping control unit 220, a storage unit 230, a charge pumping unit 240 and a voltage dividing unit 250.

The reference voltage generation unit 210 divides a predetermined voltage and generates a reference voltage VREF. The predetermined voltage may be power voltage VDD, or one of various voltages including a uniform voltage for PVT(Process, Voltage and Temperature) variation generated from a band-gap circuit of a chip.

The reference voltage generation unit 210 is designed to be enabled at every active mode. That is, the reference voltage generation unit 210 is disabled in a normal mode, is enabled at only active mode and generates a reference voltage VREF.

The reference voltage generation unit 210 includes a first serial resistor R1, a second serial resistor R2 and a current sink transistor 211. The first and second serial resistors R1 and R2 divide the predetermined voltage and generate the reference voltage VREF. The current sink transistor 211 controls a current, which flows on the first and second serial resistors R1 and R2, in response to an active pulse signal ACTIVE_PULSE.

The active pulse signal ACTIVE_PULSE is a pulse signal enabled at every active mode. While the active pulse signal ACTIVE_PULSE is enabled as ‘high’, the current sink transistor 211 is switched on, and the reference voltage generation unit 210 generates the reference voltage VREF. While the active pulse signal ACTIVE_PULSE is enabled as ‘low’, the current sink transistor 211 is switched off. The reference voltage generation unit 210 does not generate the reference voltage VREF, and does not consume a current.

The active pulse signal ACTIVE_PULSE described in the invention represents a signal which is enabled when an active command signal is applied to a memory device. The active pulse signal ACTIVE_PULSE is not necessary to be enabled at the same time with the active mode and may be set to be enabled in a predetermined time after the active mode by using a delay line.

Accordingly, the ‘at every active mode’ represents not ‘during the active mode’ but that the ‘the reference voltage generation unit 210 is enabled once if the active mode is performed once’.

The pumping control unit 220 is enabled at every active mode. That is, the pumping control unit 220 is enabled once when the active mode is performed once. But, the start and the end of the active mode are not consistent with the enable timing and the disable timing of the pumping control unit 220. An enabled width of the active pulse ACTIVE_PULSE is adjusted by a pulse width adjusting circuit.

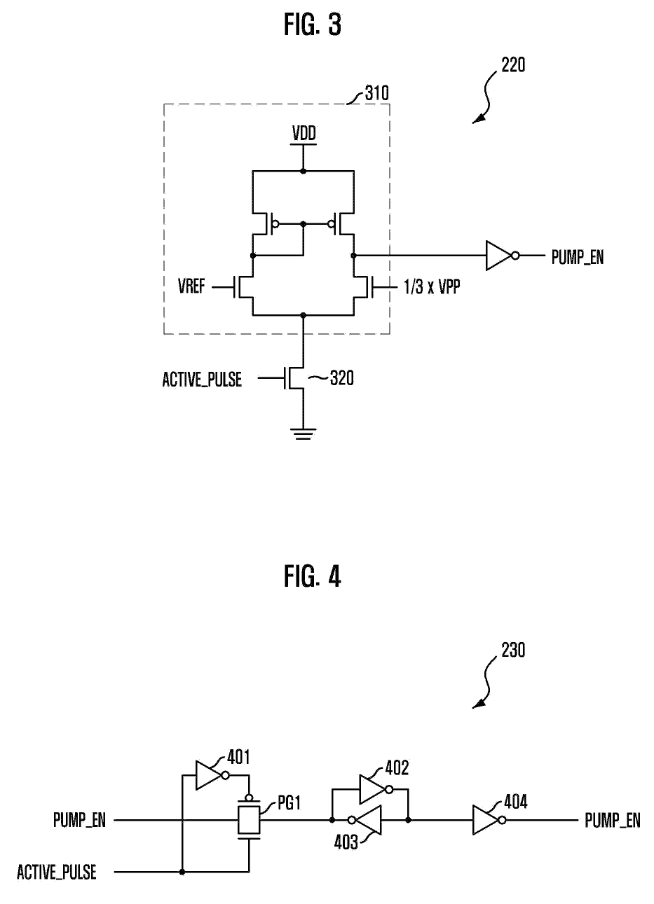

The pumping control unit 220 compares the reference voltage VREF with a fed-back voltage of a pumping voltage terminal of the charge pumping unit 240, and outputs a pumping enable signal PUMP_EN based on a comparison result. The pumping control unit 220 is not enabled always but is enabled at every active mode in response to the active pulse signal ACTIVE_PULSE. The pumping control unit 220 consumes a lower current than a conventional pumping control unit because the pumping control unit 220 is not enabled always. The pumping control unit 220 will be described in detail with reference to the accompanying FIG. 3.

The storage unit 230 stores and outputs the pumping enable signal PUMP_EN outputted from the pumping control unit 220. Because the pumping control unit 220 is not enabled always, the pumping enable signal PUMP_EN need being maintained as a predetermined level while the pumping control unit 220 is disabled. The storage unit 230 is synchronized with the active pulse signal ACTIVE_PULSE and is configured as a latch which stores the pumping enable signal PUMP_EN.

The charge pumping unit 240 drives the pumping voltage terminal by performing a charge pumping operation in response to the pumping enable signal PUMP_EN outputted from the storage unit 230. If the pumping enable signal PUMP_EN is enabled, the charge pumping operation is performed. If the pumping enable signal PUMP_EN is disabled, the charge pumping operation is not performed.

The voltage dividing unit 250 is installed between the charge pumping unit 240 and the pumping control unit 220 so that a voltage of the pumping voltage terminal is fed back from the charge pumping unit 240 to the pumping control unit 220.

Because the pumping voltage VPP is higher than the power voltage VDD, the pumping control unit 220 does not compare a level of the reference voltage VREF with a level of the pumping voltage VPP, and the level of the pumping voltage VPP is lowered as ⅓*VPP through the voltage dividing unit 250 and is fed back to the pumping control unit 220. The voltage dividing unit 250 may be configured to be enabled in response to the active pulse signal ACTIVE_PULSE.

If the voltage dividing unit 250 is configured to be enabled or disabled in response to the active pulse signal ACTIVE_PULSE, a current consumption of the voltage dividing unit 250 is reduced.

The voltage dividing unit 250 divides the pumping voltage VPP and transmits the fed-back pumping voltage, e.g., ⅓*VPP, to the pumping control unit 220. That is, in a point of view that a specific voltage is divided, the voltage dividing unit 250 is same with the reference voltage generation unit 210. Accordingly, the voltage dividing unit may have the same configuration with the reference voltage generation unit 210.

In a semiconductor memory device, because the internal voltage VPP is used to drive a word line in an active mode, the internal voltage is consumed at every active mode. Accordingly, although mode, the pumping control unit 220, the reference voltage generation unit 210 and the voltage dividing unit 250 are enabled, and the others are disabled at every active, there is no problem to generate the internal voltage VPP.

Because the pumping control unit 220, the reference voltage generation unit 210 and voltage dividing unit 250 do not consume a current while the pumping control unit 220, the reference voltage generation unit 210 and voltage dividing unit 250 are disabled, the current consumption of the internal voltage generation circuit is reduced largely.

FIG. 3 illustrates an embodiment of a detailed configuration of the pumping control unit shown in FIG. 2.

As shown in FIG. 3, the pumping control unit 220 includes a differential amplifier 310 and a bias transistor 320. The fed-back voltage ⅓*VPP of the pumping voltage terminal is applied to an input terminal of the differential amplifier 310. The reference voltage VREF is received to the other input terminal of the differential amplifier 310. The bias transistor 320 receives the active pulse signal ACTIVE_PULSE through a gate.

Because the transistor 320 is turned on while the active pulse signal ACTIVE_PULSE is enabled as ‘high’, the differential amplifier 310 compares the reference voltage VREF with the fed-back pumping voltage ⅓*VPP, and outputs the pumping enable signal PUMP_EN based on the comparison result.

However, because the transistor 320 is turned off while the active pulse signal ACTIVE_PULSE is disabled as ‘low’, a current does not flow on the differential amplifier 310, the differential amplifier 310 does not perform a comparison operation, and the pumping control unit 220 does not consume the current.

FIG. 4 illustrates an embodiment of a detailed configuration of the storage unit shown in FIG. 2.

As shown in FIG. 4, the storage unit 230 is configured as a D-latch which is synchronized with the active pulse signal ACTIVE_PULSE and stores the pumping enable signal PUMP_EN.

While the active pulse signal ACTIVE_PULSE is enabled as ‘high’, a pass gate PG1 of the storage unit 230 is opened, and the pumping enable signal PUMP_EN is inputted to the pass gate PG1 and is latched by inverters 402 and 403. An inverter 404 outputs the pumping enable signal PUMP_EN which is latched in the inverters 402 and 403.

While the active pulse signal ACTIVE_PULSE is disabled as ‘low’, a pass gate PG1 of the storage unit 230 is closed, and the pumping enable signal PUMP_EN is not inputted to the pass gate PG1. The pumping enable signal which is previously latched in the inverters 402 and 403 is outputted by the inverter 404.

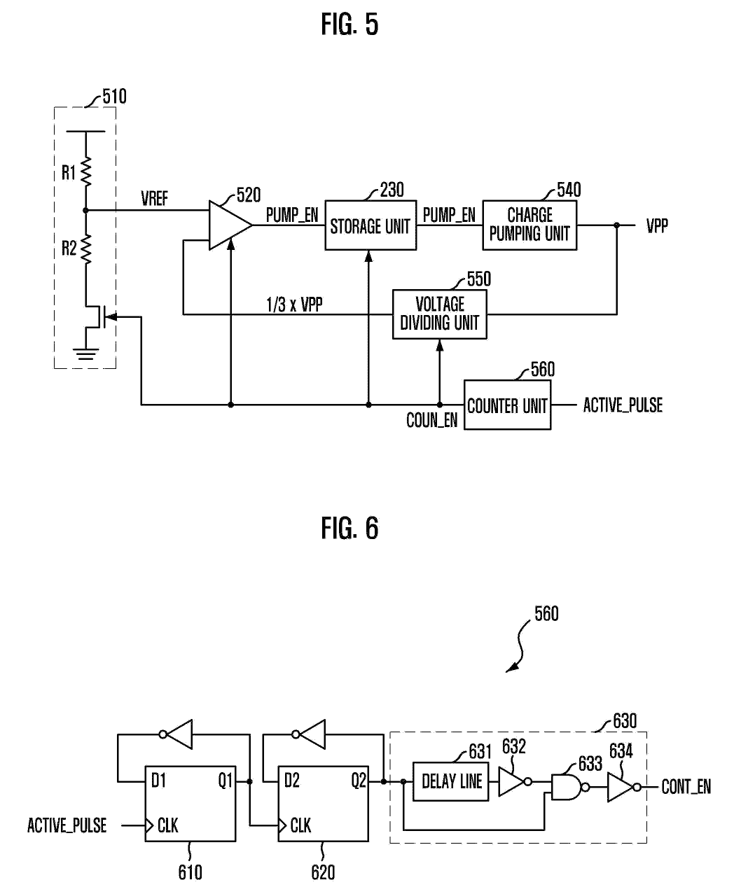

FIG. 5 is a block diagram illustrating an internal voltage generation circuit of a semiconductor memory device in accordance with another embodiment of the invention.

The internal voltage generation circuit of a semiconductor memory device in accordance with another embodiment of the invention includes a reference voltage generation unit 510, a counter unit 560, a pumping control unit 520, a storage unit 530, a charge pumping unit 540 and a voltage dividing unit 550.

The reference voltage generation unit 510 generates a reference voltage VREF. The counter unit 560 enables and outputs a control enable signal CONT_EN when an active mode is performed repeatedly larger number times than a predetermined number times.

The pumping control unit 520 is enabled in response to the control enable signal CONT_EN. The pumping control unit 520 compares the reference voltage VREF with a fed-back voltage, e.g., ⅓*VPP, of a pumping voltage terminal of the charge pumping unit 540, and outputs a pumping enable signal PUMP_EN based on a comparison result.

The storage unit 530 stores and outputs the pumping enable signal PUMP_EN outputted from the pumping control unit 520. The charge pumping unit 540 drives the pumping voltage terminal by performing a charge pumping operation in response to the pumping enable signal PUMP_EN outputted from the storage unit 530.

The voltage dividing unit 550 divides the pumping voltage VPP when a voltage of the pumping voltage terminal is fed back to the pumping control unit 520.

A basic configuration of the internal voltage generation circuit shown in FIG. 5 is same with a basic configuration of the internal voltage generation circuit shown in FIG. 2.

However, the reference voltage generation unit 510, the pumping control unit 520, the storage unit 530 and the voltage dividing unit 550 shown in FIG. 5 have the control enable signal CONT_EN instead of the active pulse signal ACTIVE_PULSE shown in FIG. 2.

The counter unit 560 enables and outputs a control enable signal CONT_EN when an active mode is performed repeatedly larger number times than predetermined number times.

The predetermined number times depend on a circuit design. For example, when the active mode is performed four times, the control enables signal CONT_EN is set to be enabled once.

The counter unit 560 may adjust an enable timing of the control enable signal CONT_EN by counting the number of enable times of the active pulse ACTIVE_PULSE. The counter unit 560 will be described in detail with reference to the accompanying FIG. 6.

When the control enable signal CONT_EN is enabled, the reference voltage generation unit 510, the pumping control unit 520, the storage unit 530 and a voltage dividing unit 550 in accordance with another embodiment of the invention are enabled.

When the control enable signal CONT_EN is disabled, the reference voltage generation unit 510, the pumping control unit 520, the storage unit 530 and a voltage dividing unit 550 in accordance with another embodiment of the invention are disabled, and reduce a current consumption.

That is, in the internal voltage generation circuit shown in FIG. 2 the reference voltage generation unit 210, the pumping control unit 220, the storage unit 230 and a voltage dividing unit 250 are enabled at every active mode. On the contrary, in the internal voltage generation circuit shown in FIG. 5, the reference voltage generation unit 510, the pumping control unit 520, the storage unit 530 and a voltage dividing unit 550 are enabled once at several times of active mode. Accordingly, the internal voltage generation circuit shown in FIG. 5 reduces a current consumption more than the internal voltage generation circuit shown in FIG. 2.

FIG. 6 illustrates an embodiment of a detailed configuration of the counter unit shown in FIG. 5.

As shown in FIG. 6, the counter unit 560 includes a first D flip-flop 610, a second D flip-flop 620 and a pulse width adjusting unit 630. The first and second D flip-flops are coupled in serial to count the active pulse signal ACTIVE_PULSE. The pulse width adjusting unit 630 receives an output of the second D flip-flop 620, adjusts a pulse width of the output, and outputs the control enable signal CONT_EN.

Q terminals Q1 and Q2 of the first and second D flip-flops 610 and 620 are inverted and are fed back to D terminals D1 and D2. The Q terminal Q1 of the first D flip-flop is inputted to a clock terminal of the second D flip-flop.

Because FIG. 6 describes an embodiment of a detailed configuration of the counter unit in case that when the active pulse signal ACTIVE_PULSE is enabled at four times, the control enable signal is enabled once, the first and second D flip-flops 610 and 620 are coupled in series.

The number of D flip-flops depends on the number of enable times of the active pulse signal ACTIVE_PULSE when the control enable signal CONT_EN is enabled once. For example, when the active pulse signal ACTIVE_PULSE is enabled at eight times, and the control enable signal CONT_EN is enabled once, three D flip-flops are coupled in series.

The first and second D flip-flops 610 and 620 use a rising edge trigger type or a falling edge trigger type. The counter 560 may be configured by using other logic circuits except D flip-flops.

Output terminals Q1 and Q2 of the first and second flip-flops are adjusted to have an initial value as ‘low’ or ‘high’ by a power signal.

The pulse width adjusting unit 630 outputs the control enable signal CONT_EN by adjusting a pulse width of the signal outputted from the Q2 terminal.

Because the reference voltage generation unit 510, the pumping control unit 520, the storage unit 530 and the voltage dividing unit 550 are activated while the control enable signal CONT_EN is enabled, the pulse width of the control enable signal CONT_EN determines an enable time of the reference voltage generation unit 510, the pumping control unit 520, the storage unit 530 and the voltage dividing unit 550.

The pulse width of the control enable signal CONT_EN is determined by a delay value of a delay line 631. The delay value of the delay line is set based on the number of enable times of the reference voltage generation unit 510, the pumping control unit 520, the storage unit 530 and the voltage dividing unit 550.

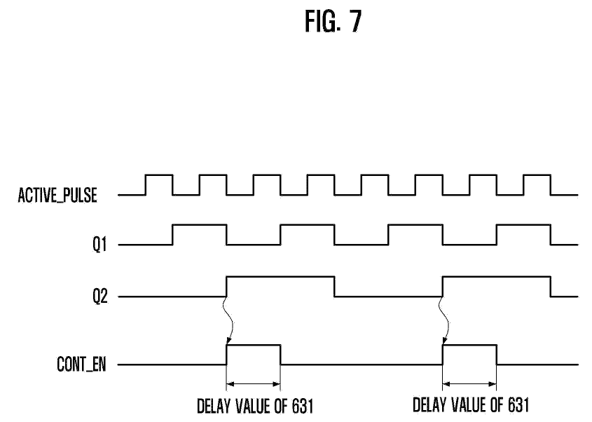

FIG. 7 is a timing block illustrating an operation of the counter unit shown in FIG. 6.

In FIG. 7, the falling edge trigger type is used as the first and second D flip-flops. As shown in FIG. 7, when the active pulse signal ACTIVE_PULSE is enabled four times, the signal of the Q2 terminal is enabled once. The signal width of the Q2 terminal is outputted as the control enable signal CONT_EN by adjusting the pulse width by the pulse width adjusting unit 630.

An internal voltage generator of a semiconductor memory device in accordance with the invention reduces a current consumption used in the generation of an internal voltage using a charge pump by enabling a pumping control unit and a reference voltage generation unit at every active mode or at predetermined number of active modes.

Because an internal voltage generation circuit is operated at every active mode, although a pumping control unit and a reference voltage generation unit is enabled always, there is no problem to generate an internal voltage.

While the invention has been described with respect to the specific embodiments, it will be apparent to those skilled in the art that various changes and modifications may be made without departing from the spirit and scope of the invention as defined in the following claims.

What is claimed is:

1. An internal voltage generation circuit of semiconductor memory device, comprising:
a reference voltage generation unit configured to generate a reference voltage;
a pumping control unit configured to be enabled at every active mode, compare the reference voltage with a fed-back voltage of a pumping voltage terminal, and output a pumping enable signal based on a comparison result;
a storage unit configured to store and output the pumping enable signal outputted from the pumping control unit; and
a charge pumping unit configured to drive the pumping voltage terminal by performing a charge-pumping operation in response to the pumping enable signal outputted from the storage unit.

2. The internal voltage generation circuit of semiconductor memory device as recited in claim 1, wherein the reference voltage generation unit is enabled at every active mode and generates the reference voltage.

3. The internal voltage generation circuit of semiconductor memory device as recited in claim 2, wherein the pumping control unit and the reference voltage generation unit are enabled in response to an active pulse which is enabled at every active mode.

4. The internal voltage generation circuit of semiconductor memory device as recited in claim 3, wherein the pumping control unit includes a differential amplifier configured to receive the fed-back voltage of the pumping voltage terminal through an input terminal thereof, and receive the reference voltage through the other input terminal thereof, and a bias transistor configured to receives the active pulse signal through a gate thereof.

5. The internal voltage generation circuit of semiconductor memory device as recited in claim 3, wherein the reference voltage generation unit includes serial resistors configured to divide a predetermined voltage and generate the reference voltage, and a current sink transistor configured to control a current which flows on the serial resistors in response to the active pulse signal.

6. The internal voltage generation circuit of semiconductor memory device as recited in claim 2, further comprising a voltage dividing unit configured to divide the voltage of the pumping voltage terminal and transmit the divided voltage as the fed-back voltage to the pumping control unit, wherein the voltage dividing unit is enabled at every active mode and performs a voltage dividing operation.

7. An internal voltage generation circuit of semiconductor memory device, comprising:
a reference voltage generation unit configured to generate a reference voltage;
a counter unit configured to enable and output a control enable signal when an active mode is performed a predetermined number times;
a pumping control unit configured to be enabled in the control enable signal, compare the reference voltage with a fed-back voltage of a pumping voltage terminal, and output a pumping enable signal based on a comparison result;
a storage unit configured to store and output the pumping enable signal outputted from the pumping control unit; and
a charge pumping unit configured to drive the pumping voltage terminal by performing a charge pumping operation in response to the pumping enable signal outputted from the storage unit.

8. The internal voltage generation circuit of semiconductor memory device as recited in claim 7, wherein the reference voltage generation unit is enabled in response to the control enable signal and generates the reference voltage.

9. The internal voltage generation circuit of semiconductor memory device as recited in claim 7, wherein the counter unit counts an active pulse signal which is enabled at every active mode, and enables and outputs the control enable signal when a predetermined number of active pulse signals are enabled.

10. The internal voltage generation circuit of semiconductor memory device as recited in claim 9, wherein the counter unit includes serial D flip-flops configured to count the active pulse signal, a pulse width adjusting unit configured to receive an output of an end D flip-flop of the serial D flip-flops, and output the control enable signal by adjusting a pulse width of the output of the end D flip-flop.

11. The internal voltage generation circuit of semiconductor memory device as recited in claim 7, wherein the pumping control unit includes a differential amplifier configured to receive the fed-back voltage of the pumping voltage terminal through an input terminal thereof, and receive the reference voltage through the other input terminal thereof, and a bias transistor configured to receives the control enable signal through a gate thereof.

12. The internal voltage generation circuit of semiconductor memory device as recited in claim 8, wherein the reference voltage generation unit includes serial resistors configured to divide a predetermined voltage and generate the reference voltage, and a current sink transistor configured to control a current which flows in the serial resistors in response to the control enable signal.

13. The internal voltage generation circuit of semiconductor memory device as recited in claim 7, wherein the storage unit is a D latch, which is synchronized with the control enable signal and stores the pumping enable signal.

14. The internal voltage generation circuit of semiconductor memory device as recited in claim 8, further comprising a voltage dividing unit configured to divide the voltage of the pumping voltage terminal and transmit the divided voltage as the fed-back voltage to the pumping control unit, wherein the voltage dividing unit is enabled in response to the control enable signal and performs a voltage dividing operation.
